(19) United States
(12) Patent Application Publication
(10) Pub. No.: US 2025/0047026 A1
(43) Pub. Date: Feb. 6, 2025

(54) MINIATURE DOUBLE-ROW WIRE END CONNECTOR

(71) Applicant: Huizhou Sanchuang Technology Co., Ltd., Huizhou (CN)

(72) Inventor: Helen Huang, Ruian (CN)

(21) Appl. No.: 18/493,612

(22) Filed: Oct. 24, 2023

(30) Foreign Application Priority Data
Aug. 2, 2023 (CN) 202322062206.4

(51) Int. Cl. H01R 13/42

(52) U.S. Cl. CPC H01R 13/42

(57) ABSTRACT

Provided is a miniature double-row wire end connector. The miniature double-row wire end connector includes a plastic housing having a cavity. No less than two groups of plug terminals are plugged into the cavity, each plug terminal is provided with an anti-drop structure, the plastic housing is correspondingly provided with a first backstop structure and an anti-reverse-plug structure, the cavity on the plastic housing is divided into a cavity body on an upper layer and a cavity body on a lower layer, and the cavity body on the upper layer and the cavity body on the lower layer are provided with several separate connecting grooves. According to the present invention, a single-row structure is changed into double rows in a mirror image manner, such that the miniature double-row wire end connector has a compact structure and a small size, thereby satisfying different requirements.

### CROSS-REFERENCE TO RELATED APPLICATIONS

This application claims priority of Chinese Patent Application No. 202322062206.4, filed on Aug. 2, 2023, the entire contents of which are incorporated herein by reference.

### TECHNICAL FIELD

The present invention relates to a connector, in particular to a miniature double-row wire end connector.

### BACKGROUND

At present, a wire end connector on the market with spacing of 1.5 mm and below can only be arranged in a single row, and more wires cannot be arranged in a limited space to achieve more functions; and moreover, due to a small space, a terminal is prone to loosening when assembled on a plastic housing, such that the terminal drops from the plastic housing during plugging, thereby affecting connection.

### SUMMARY

The objective of the present invention is to provide a miniature double-row wire end connector to solve the existing technical problem in the prior art. The present invention changes a single-row structure and a mirror image manner into double rows, saves a space, has high assembly stability of a terminal, and can avoid the problem that row wires drop when a wire end connector is used.

The specific technical solution is as follows: a miniature double-row wire end connector includes: a plastic housing having a cavity, where two sides of the plastic housing are provided with ports in communication with the cavity, no less than two groups of plug terminals are plugged into the cavity from the port on one side, each plug terminal is provided with an anti-drop structure, the plastic housing is correspondingly provided with a first backstop structure matching the anti-drop structure, the plastic housing is further provided with an anti-reverse-plug structure, the cavity on the plastic housing is divided into a cavity body on an upper layer and a cavity body on a lower layer, the cavity body on the upper layer and the cavity body on the lower layer are provided with several separate connecting grooves, and the connecting grooves on the upper layer and the lower layer are arranged in a mirror image manner.

Preferably, the plug terminal is plugged into each connecting groove, and the first backstop structure is arranged on each connecting groove.

Preferably, the first backstop structure includes a through groove arranged on the plastic housing and communicated with the connecting groove, where a terminal backstop snap having one end connected to the plastic housing is arranged on an upper side of the through groove, and the anti-drop structure is plugged into the through groove and makes contact with an end surface of the terminal backstop snap.

Preferably, the anti-drop structure includes a terminal snap arranged on a side edge of the plug terminal, where the terminal snap is tilted towards an outer side of the terminal and plugged into the through groove, and a tail end of the terminal snap makes contact with an end surface of the terminal backstop snap.

Preferably, the end surface of the terminal backstop snap is configured as an inclined surface.

Preferably, the anti-reverse-plug structure includes two anti-reverse-plug bosses, where the two anti-reverse-plug bosses are arranged on one side surface of the plastic housing at an interval.

Preferably, one side surface of the plastic housing is provided with a second backstop structure, and the second backstop structure includes a backstop boss having an inclined surface, where the inclined surface of the backstop boss is gradually inclined towards a length direction of the plastic housing.

Preferably, a top of the inclined surface of the backstop boss is provided with a vertical surface flush with an end surface of the plastic housing.

Preferably, a terminal limiting boss is arranged on one side surface of the plug terminal facing away from the terminal snap.

Preferably, the plug terminal is provided with an accommodating groove capable of accommodating the terminal snap, and the terminal snap has elasticity.

Compared with the prior art, the present invention has the following beneficial effects: the anti-drop structure is arranged on the terminal, and the first backstop structure matching the anti-drop structure is arranged on the plastic housing, thereby avoiding the sign of loosening or dropping of the terminal when the miniature double-row wire end connector is plugged, and improving use stability of the miniature double-row wire end connector; and moreover, the cavity on the plastic housing is divided into the cavity body on the upper layer and the cavity body on the lower layer, and the connecting grooves on the upper layer and the lower layer are arranged in a mirror image manner, such that a single-row structure is changed into double rows in a mirror image manner, and a space is saved, such that the miniature double-row wire end connector has a compact structure and a small size, thereby further increasing the loading number of wires, plugging multiple wires, satisfying different requirements, and effectively improving competitiveness of the miniature double-row wire end connector on the market.

### BRIEF DESCRIPTION OF THE DRAWINGS

FIG. 1 is a schematic enlarged structural diagram of the present invention;

FIG. 2 is a sectional view of the present invention;

FIG. 3 is a schematic structural diagram of a plastic housing in the present invention from an angle of view;

FIG. 4 is a schematic structural diagram of the plastic housing in the present invention from another angle of view; and

FIG. 5 is a schematic enlarged structural diagram of a portion A in FIG. 2.

### DETAILED DESCRIPTION OF THE EMBODIMENTS

In order to make the above objectives, features, and advantages of the present invention more apparent and understandable, the particular implementations of the present invention will be described in detail below in conjunction with the accompanying drawings. Many specific details are elaborated in the following description to facilitate a full understanding of the present invention. However, the present invention can be implemented in many other ways different from those described herein, and those skilled in the art can make similar improvements without violating the connotation of the present invention. Therefore, the present invention is not limited by the specific embodiments disclosed below.

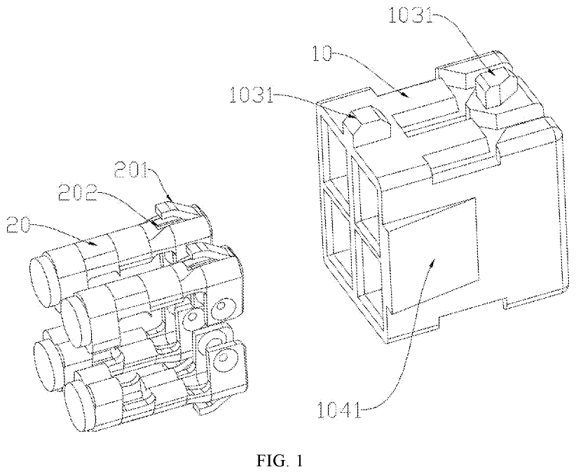

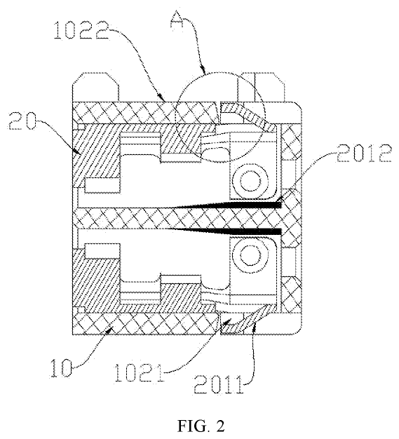

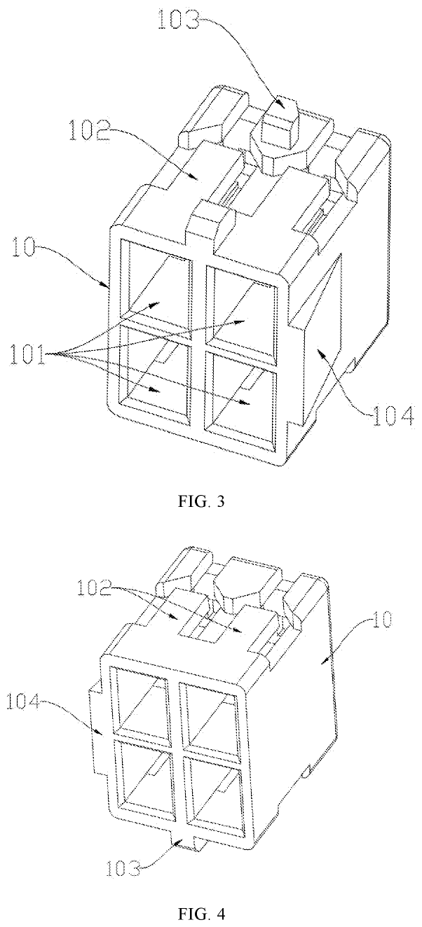

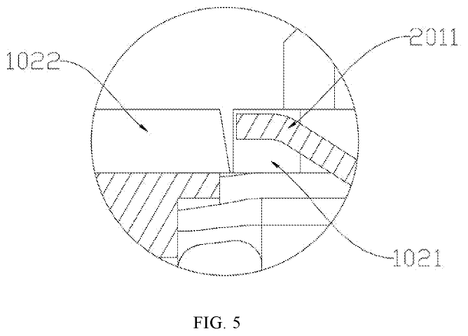

With reference to FIGS. 1-5, this embodiment provides a miniature double-row wire end connector. The miniature double-row wire end connector includes a plastic housing 10, where the plastic housing 10 has a cavity, two sides of the plastic housing 10 are provided with ports in communication with the cavity, the cavity on the plastic housing 10 is divided into a cavity body on an upper layer and a cavity body on a lower layer, the cavity body on the upper layer and the cavity body on the lower layer are provided with several separate connecting grooves 101, the connecting grooves 101 on the upper layer and the lower layer are arranged in a mirror image manner, and a plug terminal 20 is plugged into each connecting groove 101. In this embodiment, the two connecting grooves 101 are arranged on each layer, and the four connecting grooves 101 are arranged on the upper layer and the lower layer in total. In other embodiments, three or more connecting grooves 101 may be provided on each layer, and the connecting grooves may be designed and produced according to requirements, which is therefore not repeated one by one in this embodiment. Each plug terminal 20 is provided with an anti-drop structure 201, and each connecting groove 101 is correspondingly provided with a first backstop structure 102 matching the anti-drop structure 201. The anti-drop structure 201 is arranged on the terminal, and the first backstop structure 102 matching the anti-drop structure 201 is arranged on the plastic housing 10, thereby avoiding the sign of loosening or dropping of the terminal when the miniature double-row wire end connector is plugged, and improving use stability of the miniature double-row wire end connector.

Specifically, the first backstop structure 102 includes a through groove 1021 provided on the plastic housing 10 and in communication with the connecting groove 101, where a terminal backstop snap 1022 having one end connected to the plastic housing 10 is arranged on an upper side of the through groove 1021, and the anti-drop structure 201 is plugged into the through groove 1021 and makes contact with an end surface of the terminal backstop snap 1022. The anti-drop structure 201 includes a terminal snap 2011 arranged on a side edge of the plug terminal 20 and having elasticity, where the terminal snap 2011 is tilted towards an outer side of the terminal and plugged into the through groove 1021, and a tail end of the terminal snap 2011 makes contact with an end surface of the terminal backstop snap 1022. In order to prevent the terminal snap 2011 from being separated from the through groove 1021 when the plug terminal 20 is pulled and plugged, the end surface of the terminal backstop snap 1022 is configured as an inclined surface, such that during plugging, an end surface of the terminal snap 2011 slides upwards towards the inclined surface of the terminal backstop snap 1022, cannot slide downwards, and cannot be separated from the plastic housing 10 during plugging. In addition, in order to prevent the plug terminal 20 from being separated from the other port during plugging, a terminal limiting boss 2012 is arranged on one side surface of the plug terminal 20 facing away from the terminal snap 2011. The end surface of the terminal limiting boss 2012 abuts against a step of the port such that the plug terminal 20 cannot be separated from the other port during plugging. By means of the above arrangement, the plug terminal 20 can be effectively prevented from being separated from the plastic housing 10 when the plug terminal 20 and the plastic housing 10 are assembled to a plug wire, thereby improving stability of the miniature double-row wire end connector, and ensuring quality of a product.

Preferably, since the connecting groove 101 has a small space, and the terminal snap 2011 is configured to tilt outwards, it is inconvenient to plug the plug terminal 20 into the connecting groove 101. Therefore, the plug terminal 20 is provided with an accommodating groove 202 capable of accommodating the terminal snap 2011. Since the terminal snap 2011 has elasticity, the terminal snap 2011 is pressed into the accommodating groove 202 by an inner wall of the connecting groove 101 when the plug terminal 20 is plugged into the connecting groove 101. When the terminal snap 2011 is pushed to the through groove 1021, the terminal snap 2011 is restored since the terminal snap 2011 has elasticity, and the terminal snap 2011 is plugged into the through groove 1021 to prevent the plug terminal 20 from being separated from the connecting groove 101.

In addition, in order to prevent the situation that the miniature double-row wire end connector is damaged when the plastic housing 10 is reversely plugged into a connecting device, the plastic housing 10 is provided with an anti-reverse-plug structure 103. The anti-reverse-plug structure 103 includes two anti-reverse-plug bosses 1031, where the two anti-reverse-plug bosses 1031 are arranged on one side surface of the plastic housing 10 at an interval. The two anti-reverse-plug bosses 1031 are arranged, such that an operator conveniently identifies an plugging direction, and the miniature double-row wire end connector is ensured. In addition, one side surface of the plastic housing 10 is provided with a second backstop structure 104. The second backstop structure 104 includes a backstop boss 1041 having an inclined surface, where the inclined surface of the backstop boss 1041 is gradually inclined towards a length direction of the plastic housing 10. The second backstop structure 104 is arranged, such that the plastic housing 10 plugged on the connecting device is prevented from being separated, thereby ensuring stability of connection.

To sum up, according to the present invention, the anti-drop structure 201 is arranged on the terminal, and the first backstop structure 102 matching the anti-drop structure 201 is arranged on the plastic housing 10, thereby avoiding the sign of loosening or dropping of the terminal when the miniature double-row wire end connector is plugged, and improving use stability of the miniature double-row wire end connector; and moreover, the cavity on the plastic housing 10 is divided into the cavity body on the upper layer and the cavity body on the lower layer, and the connecting grooves 101 on the upper layer and the lower layer are arranged in a mirror image manner, such that a single-row structure is changed into double rows in a mirror image manner, and a space is saved, such that the miniature double-row wire end connector has a compact structure and a small size, thereby further increasing the loading number of wires, plugging multiple wires, satisfying different requirements, and effectively improving competitiveness of the miniature double-row wire end connector on the market.

In the present invention, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements. For those of ordinary skill in the art, the specific meanings of the terms described above in the present invention may be interpreted according to specific circumstances.

In the present invention, unless otherwise expressly stated and defined, a first feature being “above” or “below” a second feature may include the first and second features being in direct contact or that the first and second features being not in direct contact but being in contact by means of additional features between the first and second features. In addition, the first feature being “over”, “above” and “on the top of” the second feature includes that the first feature is over and above the second feature, or simply means that the level of the first feature is higher than that of the second feature. The first feature being “under”, “below” and “at the bottom of” the second feature includes that the first feature is under and below the second feature, or simply means that the level of the first feature is lower than that of the second feature.

Unless otherwise defined, technical terms or scientific terms used herein should have the usual meaning understood by those ordinarily skilled in the art to which the present invention belongs. The words “first”, “second”, and the like used in the description and claims of the application of the present invention do not indicate any order, quantity or importance, but are used only to distinguish different components. Likewise, the words “a” or “one”, and the like do not indicate any limitations on quantity, but rather indicate the presence of at least one.

The technical features of the above embodiments can be combined arbitrarily. For the sake of brevity, all possible combinations of the technical features in the above embodiments are not described. However, as long as the combinations of these technical features are not contradicted, it should be regarded as the scope of the description in this specification.

The above embodiments only express several implementations of the present invention, describe the implementations are specifically and detailedly, but cannot be thus understood as limiting the scope of the invention patent. It should be pointed out that for those of ordinary skill in the art, several deformations and improvements can further be made without departing from the concept of the present invention, all of which fall within the scope of protection of the present invention. Therefore, the scope of protection of the patent of the present invention should be subject to the appended claims.

1. A miniature double-row wire end connector, comprising: a plastic housing having a cavity, wherein two sides of the plastic housing are provided with ports in communication with the cavity, no less than two groups of plug terminals are plugged into the cavity from the port on one side, each plug terminal is provided with an anti-drop structure, the plastic housing is correspondingly provided with a first backstop structure matching the anti-drop structure, the plastic housing is further provided with an anti-reverse-plug structure, the cavity on the plastic housing is divided into a cavity body on an upper layer and a cavity body on a lower layer, the cavity body on the upper layer and the cavity body on the lower layer are provided with several separate connecting grooves, and the connecting grooves on the upper layer and the lower layer are arranged in a mirror image manner.

2. The miniature double-row wire end connector according to claim 1, wherein the plug terminal is plugged into each connecting groove, and the first backstop structure is arranged on each connecting groove.

3. The miniature double-row wire end connector according to claim 2, wherein the first backstop structure comprises a through groove arranged on the plastic housing and communicated with the connecting groove, wherein a terminal backstop snap having one end connected to the plastic housing is arranged on an upper side of the through groove, and the anti-drop structure is plugged into the through groove and makes contact with an end surface of the terminal backstop snap.

4. The miniature double-row wire end connector according to claim 3, wherein the anti-drop structure comprises a terminal snap arranged on a side edge of the plug terminal, wherein the terminal snap is tilted towards an outer side of the terminal and plugged into the through groove, and a tail end of the terminal snap makes contact with an end surface of the terminal backstop snap.

5. The miniature double-row wire end connector according to claim 4, wherein the end surface of the terminal backstop snap is configured as an inclined surface.

6. The miniature double-row wire end connector according to claim 1, wherein the anti-reverse-plug structure comprises two anti-reverse-plug bosses, wherein the two anti-reverse-plug bosses are arranged on one side surface of the plastic housing at an interval.

7. The miniature double-row wire end connector according to claim 1, wherein one side surface of the plastic housing is provided with a second backstop structure, and the second backstop structure comprises a backstop boss having an inclined surface, wherein the inclined surface of the backstop boss is gradually inclined towards a length direction of the plastic housing.

8. The miniature double-row wire end connector according to claim 7, wherein a top of the inclined surface of the backstop boss is provided with a vertical surface flush with an end surface of the plastic housing.

9. The miniature double-row wire end connector according to claim 4, wherein a terminal limiting boss is arranged on one side surface of the plug terminal facing away from the terminal snap.

10. The miniature double-row wire end connector according to claim 9, wherein the plug terminal is provided with an accommodating groove capable of accommodating the terminal snap, and the terminal snap has elasticity.
